(19) United States
(12) Patent Application Publication
(10) Pub. No.: US 2003/0137971 A1
(43) Pub. Date: Jul. 24, 2003

(54) Telecommunications system and method

(76) Inventors: Mark Gibson, Brighton (GB); Robert Friskney, Harlow (GB); Michael Atkinson, Harlow (GB)

Correspondence Address: William M. Lee, Jr., LEE, MANN, SMITH, MCWILLIAMS, SWEENEY & OHLSON, P.O. Box 2786, Chicago, IL, 60690-2786, US

(21) Appl. No.: 10/054,188

(22) Filed: Jan. 22, 2002

(51) Int. Cl. H04L 12/28

(52) U.S. Cl. 370/351; 370/400; 370/410; 370/389; 370/392

(57) ABSTRACT

In a multi-protocol label switched communications network, communications sessions are established on respective label switched paths each encapsulated within an existing label switched path between a start node and a destination node. The communications session is established by sending a path setup message from the start node to the destination node. The path set up message incorporate an explicit route object containing a tunnel identifier for the existing label switched path and an extended tunnel identifier specifying the label switched path for the communications session.

### FIELD OF THE INVENTION

This invention relates to packet communications systems, and in particular but in no way limited to a system and method in which packet or cell routing is controlled by the attachment of label stacks to packets or cells.

### BACKGROUND OF THE INVENTION

Communication networks are being developed in which traffic is carried within packets or cells each of which is routed to an appropriate destination on the basis of information carried in a header attached to that packet or cell. Such networks comprise a number of nodes each of which has a routing table to which reference is made to determine the processing of incoming packets. These networks include asynchronous transfer mode (ATM) and Internet Protocol (IP) networks.

A recent development in network technology has been the introduction of multi-protocol label switched (MPLS) networks. In such networks, a label distribution protocol (LDP) provides a route distribution mechanism for routing packets across a network system Multi-Protocol Label Switching was originally developed as a fast forwarding technique for IP networks. By applying a short label to the front of all IP packets going to the same destination, the computational expense of examining the whole IP header to determine forward routing is avoided. A router that processes packets in such a way is referred to as a label switched router (LSR). Further techniques have since been developed which have drastically reduced the time it takes to process such headers and MPLS has now moved into a new area of traffic engineering. This encompasses the aggregation of a number of discrete flows together such that all these flows can be treated in the same manner. This treatment may include applying the same quality of service (QoS) to all flows.

Under MPLS operation, the act of multiplexing together a number of discrete flows is performed by appending the same label to the front of each of the packets in the flow. Each labelled packet is then forwarded in exactly the same way between two label switched routers. The path that the packets traverse is called a label switched path (LSP). However, as MPLS has evolved, more detailed requirements have been placed on label switched paths, such that a particular label switched path now has a specific traffic contract, or an explicit route. This has lead to a new class of label switched paths, namely the constraint-based routed label switched path (CR-LSP). A constraint-based routed label switched path is similar to a normal label switched path, but incorporates additional requirements, e.g. specifying a particular route for the path and a particular bandwidth requirement.

Normal label switched paths are created using the label distribution protocol (LDP). This is the means by which two adjacent label switched paths share label information based on their routing table entries. Two main mechanisms have been defined for creating constraint-based routed label switched paths (CR-LSPs) These mechanisms are the constraint based label distribution protocol (CR-LDP) and the extended resource reservation protocol (RSVP-TE). The definition of these mechanisms is as follows.

1) CR-LDP [This is an extension of the basic label distribution protocol (LDP) and is defined in “Constraint-Based LSP Setup using LDP”, Work in Progress (draft-IETF-MPLS-CR-LDP-04.txt), July 2000

2) RSVP-TE [This is an extension of the resource reservation protocol (RSVP) to control the distribution of labels and is defined in “RSVP-TE: Extensions to RSVP for LSP Tunnels”, Work in Progress (draft-IETF-MPLS-RSVP-LSP-tunnel-06.txt), July 2000. RSVP is the reservation protocol defined by the IETF (Internet Engineering Task Force) and is used to signal the network for bandwidth reservation for particular flows.

When using CR-LDP to set up a path, it is possible to describe a constraint-based routed label switched path (CR-LSP) using a list of descriptors that can be one of the following four types:

IPv4 prefix—an IP version 4 label switched router (LSR) address with a mask of up to 32 bits applied from the least significant bit,

2) IPv6 prefix—an IP version 6 LSR address with a mask of up to 128 bits applied from the least significant bit,

3) Autonomous system (AS) number—a unique identifier of an IP network used in routing protocols assigned to ‘well-known’ networks,

4) Label switched path identifier (LSP-ID)—an identifier assigned by CR-LDP that uniquely identifies each CR-LSP (constraint-based routed label switched path) that emanates from an label switched router.

Note that a prefixed IP address, when used as an explicit route object, is referred to as an Abstract Node.

Reference is directed to “Resource ReSerVation Protocol (RSVP)—Version 1 Functional Specification”, RFC 2205, September 1997. Reference is also directed to RFC3209, available at: ftp://ftp.rfo-editor.org/in-notes/rfc3209.txt

Although RSVP-TE is being considered as the preferred protocol for MPLS networks, it suffers from the disadvantage that, as currently defined, it can only specify a route as a series of nodes, abstract nodes or whole network, rather than as a series of links. While RSVP-TE as currently envisaged can work well with a constrained number of label switched paths, it does not exploit the full functionality of MPLS, which has the potential to introduce a layer of hierarchy, namely LSPs nested within existing LSPs. The current RSVP-TE protocol does not however have any way of accessing this functionality.

### SUMMARY OF THE INVENTION

An object of the invention is to overcome or at least to mitigate one or more of the problems noted above.

According to a first aspect of the invention, there is provided a method of setting up a communications session via a tunnel between first and second nodes, the method comprising: sending a path set up message from the first node to the second node, wherein said path set up message incorporates an explicit route object containing a session object comprising a tunnel end point address uniquely specifying a label switched path for said communications session.

Advantageously, the session object comprises a tunnel identifier, and an extended tunnel identifier.

The method may be performed under the control of software in machine readable form on a storage medium.

Advantageously, the path message also contains a session attribute object instructing a destination node to add a session filter into an existing reservations thereby explicitly sharing the reservation.

The reservation for the encapsulated session may be established at each traversed node indicated by the tunnel identifier.

Preferably, a reservation is made only at either end of the tunnel that the new session has been routed along.

Recursive label stacks may be established on an as-needed basis between label switched routers.

The method provides an enhancement of the RSVP-TE protocol such that an explicit route through an MPLS network can be described in terms of the MPLS links over which it should be established.

As the tunnel ID and the extended tunnel ID completely and uniquely define a particular label switched path, by including these in an explicit route object, they can be used to describe part or all of a route across an MPLS network.

According to another aspect of the invention there is provided a method of reserving a label switched path nested within an existing label switched path so as to establish a communications session between a start node and a destination node in a multi-protocol label switched communications network, the method comprising: sending a path set up message from the first node to the second node via one or more intermediate nodes, said path set up message incorporating an explicit route objet containing a tunnel identifier for said existing label switched path and an extended tunnel identifier, said tunnel identifier and extended tunnel identifier together specifying the label switched path for said communications session.

According to another aspect of the invention there is provided a method of setting up a communications session on a label switched path encapsulated within an existing label switched path between a first node and a second node via one or more intermediate nodes, said first and second nodes being disposed at respective ends of the existing label switched path, the method comprising:

at said first node, defining a new path state and sending a path set up message to the second node via said one or more intermediate nodes, said path set up message incorporating an explicit route object containing a tunnel identifier for said existing label switched path and an extended tunnel identifier, said tunnel identifier and extended tunnel identifier together specifying the label switched path for said communications session;

at each intermediate node, defining a new path state and forwarding the path message with said explicit route object;

at said second node, establishing a reservation state, and returning said reservation state to the first node via said one or more intermediate nodes;

at each said intermediate node, defining a new reservation state and forwarding said label, and,

at said first node, installing the reservation state with a label stack consisting of label for the existing label switched path as the top label and the newly returned label as the bottom label.

According to another aspect of the invention there is provided a method of setting up a communications session on a label switched path encapsulated within an existing label switched path between a first node and a second node via one or more intermediate nodes, said first and second nodes being disposed at respective ends of the existing label switched path, the method comprising:

at said first node, defining a new path state and sending a path set up message to the second node via said one or more intermediate nodes, said path set up message incorporating an explicit route object containing a tunnel identifier for said existing label switched path and an extended tunnel identifier, said tunnel identifier and extended tunnel identifier together specifying the label switched path for said communications session;

tunneling the path set up message via the existing label switched path to the second node;

at said second node, establishing a reservation state, and returning the reservation state to the first node with said first node identified as the previous hop (phop) router so as to tunnel the reservation back to the first node; and,

at said first node, installing the reservation state with a label stack consisting of label for the existing label switched path as the top label and the newly returned label as the bottom label.

The method provides an extension to the RSVP-TE protocol and its processing that allows LSPs to be established using other (existing) LSPs, and their resources if any, as part of their route. Further, the method allows aggregate groups of LSPs to be manipulated as a single entity, e.g. to subdivide the same division of total link bandwidth, and may be used e.g. for running an MPLS network over an MPLS virtual private network (VPN) and/or for overall traffic engineering or general management purposes of a network with a significant number of LSPs

According to another aspect of the invention there is provided a path setup message for reserving a label switched path nested within an existing label switched path so as to establish a communications session between a start node and a destination node in a multi-protocol label switched communications network, said path set up message incorporating an explicit route object containing a tunnel identifier for said existing label switched path and an extended tunnel identifier, said tunnel identifier and extended tunnel identifier together specifying the label switched path for said communications session.

According to another aspect of the invention there is provided a multi-protocol label switched communications network in which communications sessions are established on respective label switched paths each encapsulated within an existing label switched path between a start node and a destination node, the network comprising; message sending means disposed at the start node for sending a path set up message from the start node to the destination node, wherein said path set up message incorporates an explicit route object containing a tunnel identifier for said existing label switched path and an extended tunnel identifier, said tunnel identifier and extended tunnel identifier together specifying the label switched path for said communications session.

According to another aspect of the invention there is provided a network node for use in a multi-protocol label switched communications network in which communications sessions are established on respective label switched paths each encapsulated within an existing label switched path between said node and a destination node, the network node comprising: message sending means for sending a path set up message to the destination node, wherein said path set up message incorporates an explicit route object containing a tunnel identifier for said existing label switched path and an extended tunnel identifier, said tunnel identifier and extended tunnel identifier together specifying the label switched path for said communications session.

Advantageously, new label switched paths may be set up within a concatenated sequence of existing label switched paths or tunnels.

### BRIEF DESCRIPTION OF THE DRAWINGS

Embodiments of the invention will now be described with reference to the accompanying drawings in which:—

FIG. 1 illustrates the use of the RSVP-TE protocol to define an end-to-end path in a communications network according to the prior art;

FIG. 2 shows a path reservation process according to a first embodiment of the invention; and

FIG. 3 shows a path reservation process according to a second embodiment of the invention.

### DESCRIPTION OF PREFERRED EMBODIMENTS

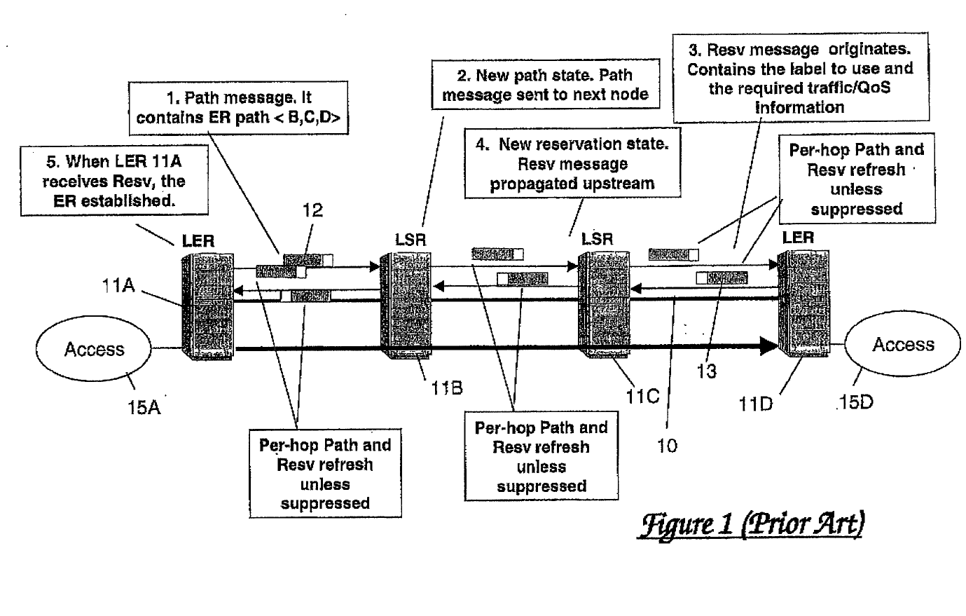

Referring first to FIG. 1, which is introduced for explanatory and comparative purposes, this figure, which is a combined block schematic and flow diagram, shows the use of the RSVP-TE protocol in reserving a path 11 across a network from edge router LER A to edge router LER D via label switched routers LSR B and LSR C. The edge routers LER A and LER D may be coupled to access networks 15A, 15D providing user access to the network. The process of establishing a constraint-based routed label switched path (CR-LSP) using RSVP-TE is similar to that of making a successful reservation in normal resource reservation protocol (RSVP). Typical constraints include for example specification of a defined quality of service and an explicit route. A path message 1 containing the path <B, C, D>is sent from edge router LER A via label switched routers LSR B and LSR C to the desired destination. This path message contains the quality of service (QoS) parameters for the path reservation. At label switched router LSR-B a new path state block (PSB) is created and a path message 2 is sent via the next node (LSR-C) to edge router LER-D. A reservation request (Resv) response message 3 containing the label to be used and the required traffic/quality of service information is then returned to the sender, and a new reservation state message 4 is propagated upstream. Reception of this upstream message 5 at the originating edge router LER A establishes the reservation of the path in the traversed routers. Per-hop path and reservation refresh messages 6 are propagated unless suppressed.

In RSVP-TE, this process is optionally enhanced by including information about the explicit route in the path message, that serves to determine the forward path of the path message, and also an optional object that records the route traversed. This latter parameter is useful to a management layer.

The reservation (Resv) response is then used to allocate the labels for the upstream label switched routers LSRs to use on a per-hop basis. It also, as per normal RSVP, makes a reservation for the new session.

To describe the route to take across an MPLS network for a new LSP (label switched path) reservation, RSVP-TE uses an explicit route object (ERO) to define a route for the new LSP between two defined label switched routers (LSR). This explicit route object contains a prefixed IPv4 or IPv6 address of a (group of) LSR(s) or an AS (autonomous system) number.

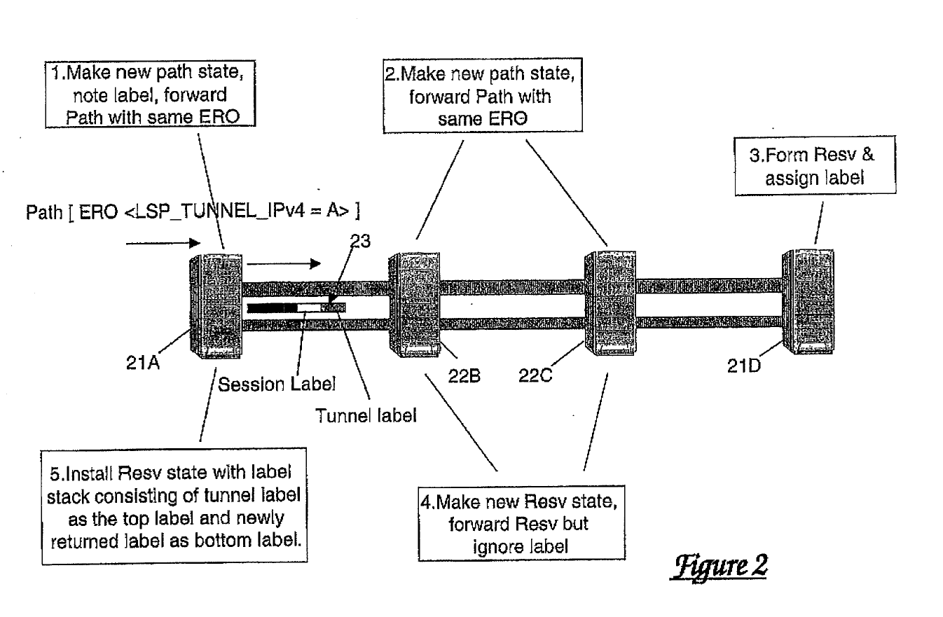

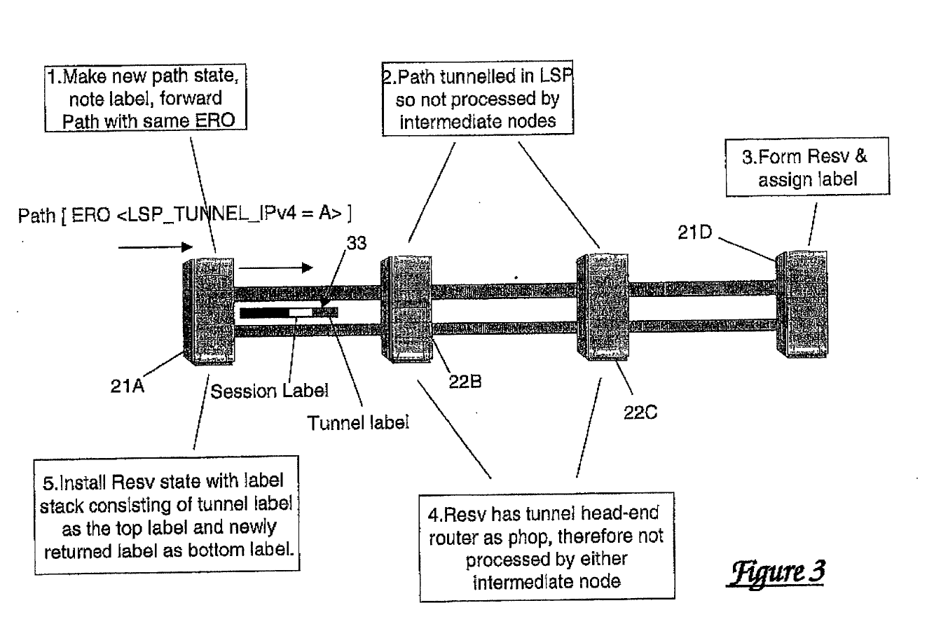

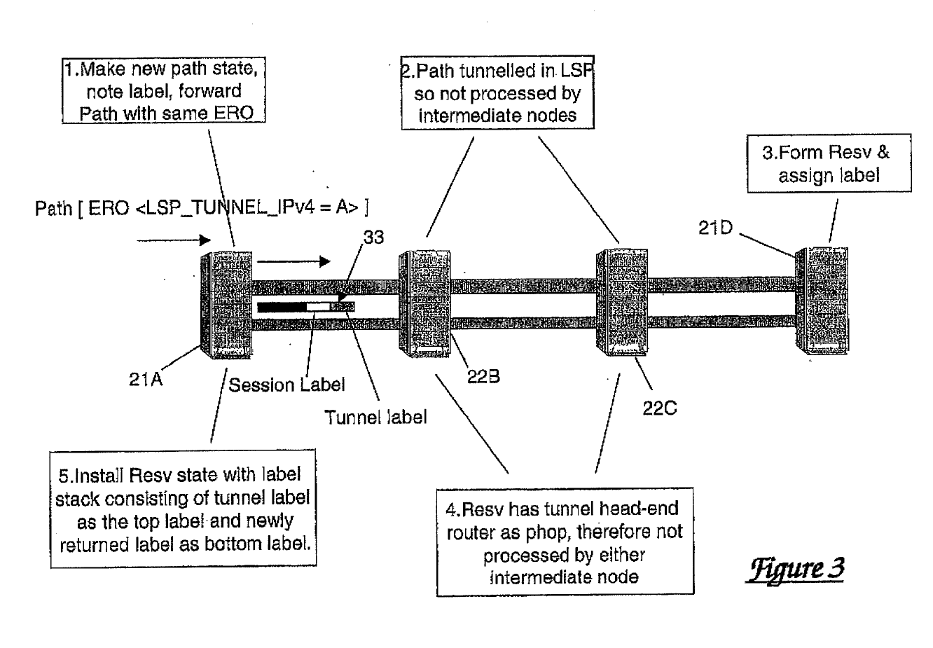

Having described the background prior art, reference is now directed to FIGS. 2 and 3 which respectively show in schematic form first and second embodiments of the invention.

In our arrangement and method, each new path reservation is described by either an LSP_TUNNEL_IPv4 session object or an LSP_TUNNEL_IPv6 session object, depending on whether the egress label switched router (LSR) uses IPv4 or IPv6 addressing respectively. The crucial field is the destination router's address format. This can be effected by running either an Ipv4 or Ipv6 network and using the appropriate object. In a further application both protocols could be run on the same network and would thus originate and terminate in different addressing schemes. For simplicity, the term Ipxx in the description below will be understood to mean Ipv4 or Ipv6 as appropriate. In each embodiment described below, paths are established that are nested within currently established paths within tunnels. In this arrangement and method, there is no requirement for the start and end of a path to coincide with the start and end of any tunnel containing that path. The arrangements and methods described below with reference to FIGS. 2 and 3 provide mechanisms of establishing reservations that can be made using a link-based approach that re-uses an existing LSP reservation.

Both the session objects (Ipv4 or Ipv6) feature a tunnel endpoint address that comprises a sixteen-bit tunnel ID, and an extended tunnel ID that is typically set to zero but can also be set to the IP address of the outgoing interface of the label switched router from which the label switched path (LSP) leaves. The tunnel ID and the extended tunnel ID remain constant over the lifetime of the label switched path and are therefore together a unique identifier of the path. The session object containing the tunnel ID and the extended tunnel ID is incorporated in an explicit route object (ERO) that is included in the path set up message. The tunnel identifier and the extended tunnel identifier together identify the label switched path that is to be established.

In our arrangement and method, tunnels are constituted by label switched paths, although there will also be label switched paths which are not tunnels.

FIG. 2 illustrates the establishment of a label switched path from a source edge router 21A to a destination edge router 21D via label switched routers (nodes) R and 29C disposed at either ends of an established label switched path or tunnel it will of course be appreciated that, for ease and clarity of explanation, FIG. 2 is a highly simplified diagram and that in a typical network there will be a large number of nodes along a path between the source and destination. It will also be appreciated that, although the node 21D is referred to as the destination nodes it is in fact the node at the end of the established label switched path or tunnel, and that new label switched paths may be set up within this tunnel and extending through one or more further tunnels (not shown) via the node 21D. The node 21D thus is not necessarily the end of the new label switched path which will in general be set up via a number of existing label switched paths or tunnels. A new path may thus be set up within a concatenated sequence of tunnels. It is not necessary for the start and end of a new path to coincide with the start and end of a tunnel.

When the edge router 21A wishes to establish constraint based label switched path (CR-LSP), preferably using the RSVP-TE protocol, that node sends a path message 23 that contains the session object that uses the LSP_TUNNEL_IPxx object to identify uniquely the constraint based label switched path. Each node 22B, 2C that the path message passes through establishes the state for this constraint based label switched path by storing in the node information in the form of a new path state block (PSB). Each node in the constraint based label switched path therefore has logged the LSP_TUNNEIL_IPxx object.

In this first embodiment, the path message may also contain an object specifying the “Ingress node may reroute” flag. This requires the destination node 21D to make the reservation with its filter style set to “Shared Explicit”. This has the effect of adding a new session filter into an existing reservation, thereby explicitly sharing the reservation.

When a path message is received at a node 22B, 22C, that node examines the explicit route object (ERO) In the message to determine flow to forward the message. If an LSP_TUNNEL_IPxx object is found, the node performs the following sequence:

The node determines whether it has a matching path state block (PSB) entry for the LSP_TUNNEL_IPxx object

If the node finds a match, it then determines the next-hop router for this CR-LSP, updates the path state block information and forwards the path message to the next hop router.

If the router is the head-end of the CR-LSP, it updates its path state for this new path message, notes the outgoing label for this CR-LSP, and then forwards the path message to the next hop router in this CR-LSP.

In either case, the router does not remove the LSP_TUNNEL_IPxx object from the explicit route object. Effectively, in the strict sense of RSVP-TE, the router replaces the LSP_TUNNEL_IPxx object in the explicit route object (ERO) with an identical copy of this tunnel object once it has been processed, so that when the path message is forwarded, the first ERO sub-objet in the message remains as the LSP_TUNNEL_IPxx object.

If a router determines it is the last node in the CR-LSP, it removes the LSP_TUNNEL_IPxx object from the explicit route object and makes a forwarding decision based on the next object in the explicit route object.

This process is repeated for each instance of the LSP_TUNNEL_IPxx object contained in the explicit route object.

When the path message reaches the final node 21D for the new CR-LSP (i.e. there are no more ERO sub-objects to process) this node sends a response to the originating router 21A to establish the reservation state across this newly defined path. This Resv message is responsible for communicating the label to be used by the session on a per-hop basis using the label object.

For each segment of the reservation that was identified by an LSP_TUNNEL_IPxx object, the following operation is performed:

If the router is the tail end of a CR-LSP used in this new label switched path, it removes any downstream label object (if any). The router then defines a new label to be allocated to this newly tunnelled session which it places into the label objet, and then forwards the Resv message to the previous hop RSVP-TE router in the CR-LSP. The “Shared Explicit” filter type is used such that this new session shares the resources previously allocated to the outer CR-LSP.

If the router is neither the tail nor the head-end of a CR-LSP, it forwards the Resv message without altering the label object. However, the router update its Resv state block to accommodate this new session, noting that it shares resources with the outer CR-LSP.

If the router is the head-end of the CR-LSP it removes the label object. This provides the label that identifies the tunnelled session. The router then adds the CR-LSP label to use as the top label in a two-label stack and binds this label stack to the new session. The router also updates its path state block to share resource for this new session with the existing CR-LSP.

The two-label stack that has now been created at the head-end router is sufficient to route this session over the CR-LSP such that when it arrives at the far end of this CR-LSP, its contents are uniquely distinguishable. The top label is swapped to traverse the CR-LSP, then popped at the tail-end router and the session label used to forward the session contents.

Reference is now made to FIG. 3 that depicts in schematic form a further embodiment of the invention. In this embodiment, the intermediate nodes ignore the path request message 33 and simply pass it on until the message reaches the destination router. The path message is tunneled in a label switched path, so the setup message is not processed by the intermediate nodes. Similarly, the returned reservation has the tunnel head end router identified as the “phop” and is thus not processed by the intermediate nodes. Indeed, the returned reservation may not even traverse each of these intermediate nodes as it is sent by the shortest path to the head of the path.

As before, the session object containing the tunnel ID and the extended tunnel ID is incorporated in an explicit route object (ERO) to provide unique identification of the path. In the embodiment of FIG. 3, the CR-LSP identified by the LSP_TUNNEL_IPxx object in the explicit route object is utilised to carry the path message in-band. At the head-end of the CR-LSP, the label used at the router 21A to forward information over the tunnel is applied to the front of the path message. This message is forwarded to the tail end of the tunnel, going through all intermediate nodes in the tunnel (existing LSP) without any RSVP processing. Thus, the tail-end router records in its path state block for this session that the head-end router of the tunnel is the previous hop RSVP router (phop).

When the Resv message is returned by the tail end node, it is sent directly to its recorded phop as per the instructions in RFC2209 regarding Resv processing, i.e. to the head-end node. In this reservation process a single label is placed in the label objet. When the originating label switched router receives this Resv message, it adds this returned label to the outgoing label for the identified CR-LSP to form a two-label stack. This stack has the original CR-LSP label at the top label and the newly assigned label as the lower label.

In this embodiment, no reservation state needs to be stored at the intermediate nodes 22B, 22C that support the CR-LSP. Therefore the head-end router advantageously performs admission control before admitting a new session to be placed into an existing CR-LSP.

In the case where multiple LSPs are established within one tunnel, signalling traffic through that tunnel may be reduced by using the standard RSVP-TE HELLO mechanism through that tunnel, rather than refreshing every LSP individually

The embodiment of FIG. 3 allows recursive use, such that tunnels may act as routing hops for tunnels which acted as routing hops for further tunnels, and so on.

It will be understood that the above description of a preferred embodiment is given by way of example only and that various modifications may be made by those skilled in the art without departing from the spirit and scope of the invention.

1. A method of setting up a communications session on a label switched path encapsulated within an existing label switched path between a first node and a second node, the method comprising: sending a path set up message from the first node to the second node, wherein said path set up message incorporates an explicit route object containing a tunnel identifier for said existing label switched path and an extended tunnel identifier, said tunnel identifier and extended tunnel identifier together specifying the label switched path for said communications session.

2. A method as claimed in claim 1, wherein the path message further contains a session attribute object instructing the second node to add a session filter into an existing reservation, thereby explicitly sharing the reservation.

3. A method as claimed in claim 2, wherein a reservation for the encapsulated session indicated by the tunnel identifier is established at each traversed node along the path for said communications session.

4. A method as claimed in claim 2, wherein a path reservation is made only at either end of the tunnel within which the path for the communications session has been routed.

5. A method as claimed in claim 4, wherein recursive label stacks are established on an as-needed basis between said start and destination nodes.

6. A method as claimed in claim 1, and further comprising setting up said label switched path within one or more further existing label switched paths accessed via said second node.

7. A method as claimed in claim 1, and performed under the control of software in machine readable form on a storage medium.

8. A method of reserving a label switched path nested within an existing label switched path so as to establish a communications session between a first node and a second node in a multi-protocol label switched communications network, the method comprising: sending a path set up message from the first node to the second node via one or more intermediate nodes, said path set up message incorporating an explicit route object containing a tunnel identifier for said existing label switched path and an extended tunnel identifier, said tunnel identifier and extended tunnel identifier together specifying a label switched path for said communications session.

9. A method of setting up a communications session on a label switched path encapsulated within an existing label switched path between a first node and a second node via one or more intermediate nodes, said first and second nodes being disposed at respective ends of the existing label switched path, the method comprising:
at said first node, defining a new path state and sending a path set up message to the second node via said one or more intermediate nodes, said path set up message incorporating an explicit route object containing a tunnel identifier for said existing label switched path and an extended tunnel identifier, said tunnel identifier and extended tunnel identifier together specifying the label switched path for said communications session;
at each intermediate node, defining a new path state and forwarding the path message with said explicit route object;
at said second node, establishing a reservation state, and returning said reservation state to the first node via said one or more intermediate nodes;
at each said intermediate node, defining a new reservation state and forwarding said label; and,
at said first node, installing the reservation state with a label stack consisting of label for the existing label switched path as the top label and the newly returned label as the bottom label.

10. A method of setting up a communications session on a label switched path encapsulated within an existing label switched path between a first node and a second node via one or more intermediate nodes, said first and second nodes being disposed at respective ends of the existing label switched path, the method comprising:
at said first node, defining a new path state and sending a path set up message to the second node via said one or more intermediate nodes, said path set up message incorporating an explicit route object containing a tunnel identifier for said existing label switched path and an extended tunnel identifier, said tunnel identifier and extended tunnel identifier together specifying the label switched path for said communications session;
tunneling the path set up message via the existing label switched path to the second node;
at said second node, establishing a reservation state, and returing the reservation state to the first node with said first node identified as the previous hop (phop) router so as to tunnel the reservation back to the first node; and,
at said first node, installing the reservation state with a label stack consisting of label for the existing label switched path as the top label and the newly returned label as the bottom label.

10. A path setup message for reserving a label switched path nested within an existing label switched path so as to establish a communications session between a first node and a second node in a multi-protocol label switched communications network, said path set up message incorporating an explicit route object containing a tunnel identifier for said existing label switched path and an extended tunnel identifier, said tunnel identifier and extended tunnel identifier together specifying a label switched path for said communications session.

11. A label switched communications network in which communications sessions are established on respective label switched paths each encapsulated within an existing label switched path between a first node and a second node, the network comprising: message sending means disposed at the start node for sending a path set up message from the start node to the destination node, wherein said path set up message incorporates an explicit route object containing a tunnel identifier for said existing label switched path and an extended tunnel identifier, said tunnel identifier and extended tunnel identifier together specifying the label switched path for said communications session.

12. A network as claimed in claim 11, wherein the path message further contains a session attribute object instructing the second node to add a session filter into an existing reservation, thereby explicitly sharing the reservation.

13. A network as claimed in claim 12, wherein a reservation for the encapsulated session indicated by the tunnel identifier is established at each traversed node along the path for said communications session.

14. A network as claimed in claim 12, wherein a path reservation is made only at either end of the existing label switched path within which the path for the communications session has been routed.

15. A network as claimed in claim 14, wherein recursive label stacks are established on an as-needed basis between said first and second nodes.

16. A network node for use in a multi-protocol label switched communications network in which communications sessions are established on respective label switched paths each encapsulated within an existing label switched path between said node and a further node, the network node comprising: message sending means for sending a path set up message to the further node, wherein said path set up message incorporates an explicit route object containing a tunnel identifier for said existing label switched path and an extended tunnel identifier, said tunnel identifier and extended tunnel identifier together specifying the label switched path for said communications session.

17. A method of setting up a communications session via a tunnel between first and second nodes, the method comprising: sending a path set up message from the first node to the second node, wherein said path set up message incorporates an explicit route object containing a session object comprising a tunnel end point address uniquely specifying a label switched path for said communications session.
